(19) United States
(12) Patent Application Publication
(10) Pub. No.: US 2026/0277087 A1
(43) Pub. Date: Sep. 17, 2026

(54) OPTICAL DEVICE AND PROJECTION DEVICE

(71) Applicant: Coretronic Corporation, Hsin-Chu (TW)

(72) Inventor: Chia-Lun Tsai, Hsin-Chu (TW)

(73) Assignee: Coretronic Corporation, Hsin-Chu (TW)

(21) Appl. No.: 19/557,015

(22) Filed: Mar. 4, 2026

Related U.S. Application Data
(60) Provisional application No. 63/772,777, filed on Mar. 17, 2025.

(30) Foreign Application Priority Data
May 28, 2025 (CN) 202510699436.2

(51) Int. Cl. G03B 21/20; G02B 26/00; G03B 21/16

(52) U.S. Cl. CPC G03B 21/204; G02B 26/008; G03B 21/16

(57) ABSTRACT

An optical device includes a light-collecting element disposed on a first side of a virtual plane and a wavelength conversion element including a substrate, a wavelength conversion layer, and a counterweight structure. The substrate includes a geometric center and a wavelength conversion region surrounding the geometric center, and a top surface of the substrate is located on the virtual plane. The wavelength conversion layer is disposed on the wavelength conversion region. A first distance between the light-collecting element and the wavelength conversion layer is less than a second distance between the light-collecting element and the top surface of the substrate. A top surface of the wavelength conversion layer is located on the first side. The counterweight structure is connected to the substrate and located on a second side of the virtual plane opposite to the first side. A projection device including the optical device is also provided.

### CROSS-REFERENCE TO RELATED APPLICATION

This application claims the priority benefit of U.S. provisional applications serial no. 63/772,777, filed on March 17, 2025 and China application serial no. 202510699436.2, filed on May 28, 2025. The entirety of the above-mentioned patent application is hereby incorporated by reference herein and made a part of this specification.

### BACKGROUND

### Technical Field

The invention relates to an optical device and a projection device including the optical device.

### Description of Related Art

At present, a wavelength conversion component (e.g., a phosphor wheel) has multiple structures (e.g., a counterweight element or a heat dissipation structure) and a wavelength conversion element disposed on its substrate. The multiple structures and the wavelength conversion element may be disposed on the same side of the substrate and protrude from the substrate. The thickness of the multiple structures may be greater than the thickness of the wavelength conversion element. In order for the wavelength conversion component to have improved conversion efficiency, the light-collecting component and the wavelength conversion component need to be spaced apart by a specific distance. However, during the process of assembling the light-collecting component and the wavelength conversion component, there is interference between the light-collecting component and the multiple structures, so that the light-collecting component and/or the wavelength conversion component may be damaged. Alternatively, in order to prevent the light-collecting component from colliding with the multiple structures of the wavelength conversion component, the light-collecting component cannot be spaced apart from the wavelength conversion component by the specific distance, so that the conversion efficiency of the wavelength conversion component is poor.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

The invention provides an optical device and projection device capable of improving conversion efficiency of a wavelength conversion component.

Other objects and advantages of the invention may be further illustrated by the technical features broadly embodied and described as follows.

In order to achieve one, part of, or all of the above objectives or other objectives of the above, an embodiment of the invention provides an optical device including a light-collecting component and a wavelength conversion component. The light-collecting component is disposed on a first side of a virtual plane. The wavelength conversion component includes a substrate, a wavelength conversion layer, and a counterweight structure. The substrate includes a wavelength conversion region and a geometric center. The wavelength conversion region surrounds the geometric center, and a top surface of the substrate is located on the virtual plane. The wavelength conversion layer is disposed on the wavelength conversion region. A first distance is provided between the light-collecting component and a top surface of the wavelength conversion layer. A second distance is provided between the light-collecting component and the top surface of the substrate. The first distance is less than the second distance. The top surface of the wavelength conversion layer is located on the first side of the virtual plane. The counterweight structure is connected to the substrate and located on a second side of the virtual plane, and the first side is opposite to the second side.

In order to achieve one, part of, or all of the above objectives or other objectives of the above, an embodiment of the invention provides a projection device including an illumination system, a light valve module, and a lens module. The illumination system is configured to provide an illumination light beam and includes a light source module and an optical device. The light source module is configured to provide a laser light beam. The optical device includes a light-collecting component and a wavelength conversion component. The light-collecting component is disposed on a transmission path of the laser light beam from the light source module and is disposed on a first side of a virtual plane. The wavelength conversion component is disposed on a transmission path of the laser light beam from the light-collecting component and is configured to convert the laser light beam into a converted light beam. The illumination light beam includes at least one of the laser light beam and the converted light beam. The wavelength conversion component includes a substrate, a wavelength conversion layer, and a counterweight structure. The substrate includes a wavelength conversion region and a geometric center. The wavelength conversion region surrounds the geometric center, and a top surface of the substrate is located on the virtual plane. The wavelength conversion layer is disposed on the wavelength conversion region. A first distance is provided between the light-collecting component and a top surface of the wavelength conversion layer. A second distance is provided between the light-collecting component and the top surface of the substrate. The first distance is less than the second distance. The top surface of the wavelength conversion layer is located on the first side of the virtual plane. The counterweight structure is connected to the substrate and located on a second side of the virtual plane, and the first side is opposite to the second side. The light valve module is disposed on a transmission path of the illumination light beam and is configured to convert the illumination light beam into an image light beam. The lens module is disposed on a transmission path of the image light beam and is configured to project the image light beam out of the projection device.

To sum up, the optical device and the projection device of the embodiments of the invention have at least one of the following advantages. The light-collecting component and the top surface of the wavelength conversion layer of the wavelength conversion component are located on the first side of the virtual plane, the counterweight structure is located on the second side of the virtual plane, the top surface of the substrate is located on the virtual plane, and a specific distance is provided between the light-collecting component and the wavelength conversion component. In this way, the wavelength conversion component has improved conversion efficiency. Further, when the wavelength conversion component rotates relative to the light-collecting component, or during the assembly process of the optical device, collision between the light-collecting component and the substrate and the counterweight structure that may cause damage is avoided.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 is a block diagram of a projection device according to an embodiment of the invention.

FIG. 2 is an exploded view of a wavelength conversion component of FIG. 1.

FIG. 3 is a top view of the wavelength conversion component of FIG. 1.

FIG. 4 is a cross-sectional schematic view of an optical device corresponding to FIG. 2.

FIG. 5 is a schematic view of a wavelength conversion component according to an embodiment of the invention.

FIG. 6 is a cross-sectional schematic view of the optical device corresponding to FIG. 5.

FIG. 7 is a cross-sectional schematic diagram of the optical device according to an embodiment of the invention.

FIG. 8 is a schematic view of a wavelength conversion component according to an embodiment of the invention.

FIG. 9 is a cross-sectional schematic view of the optical device corresponding to FIG. 8.

FIG. 10 is a schematic view of a wavelength conversion component according to an embodiment of the invention.

FIG. 11 is a cross-sectional view of the wavelength conversion component of FIG. 10.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as "top," "bottom," "front," "back," etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

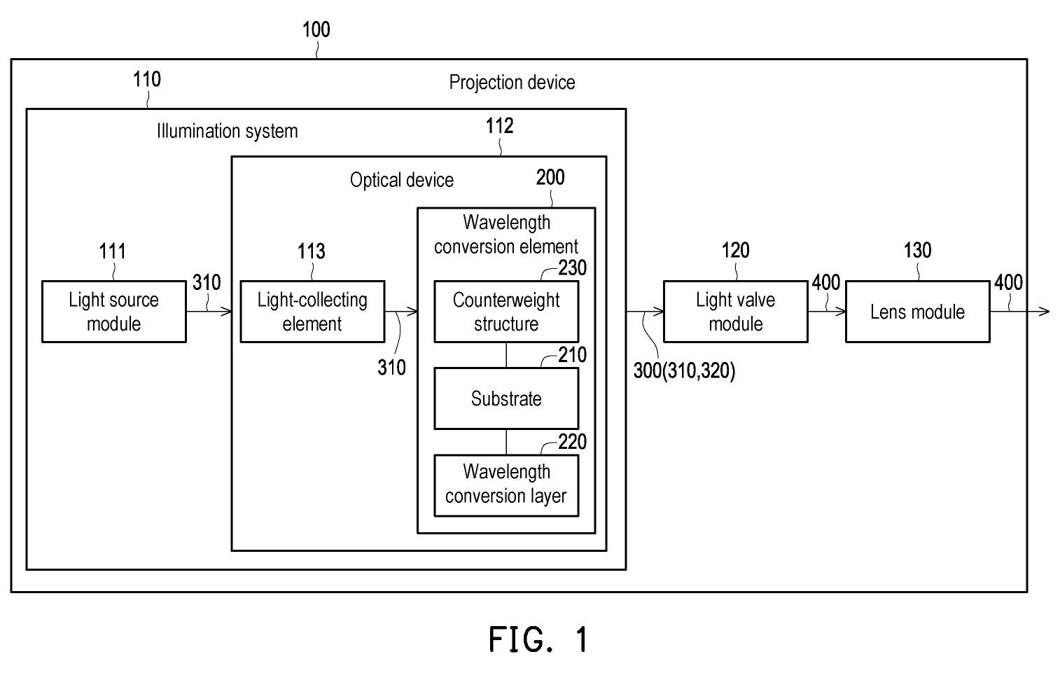

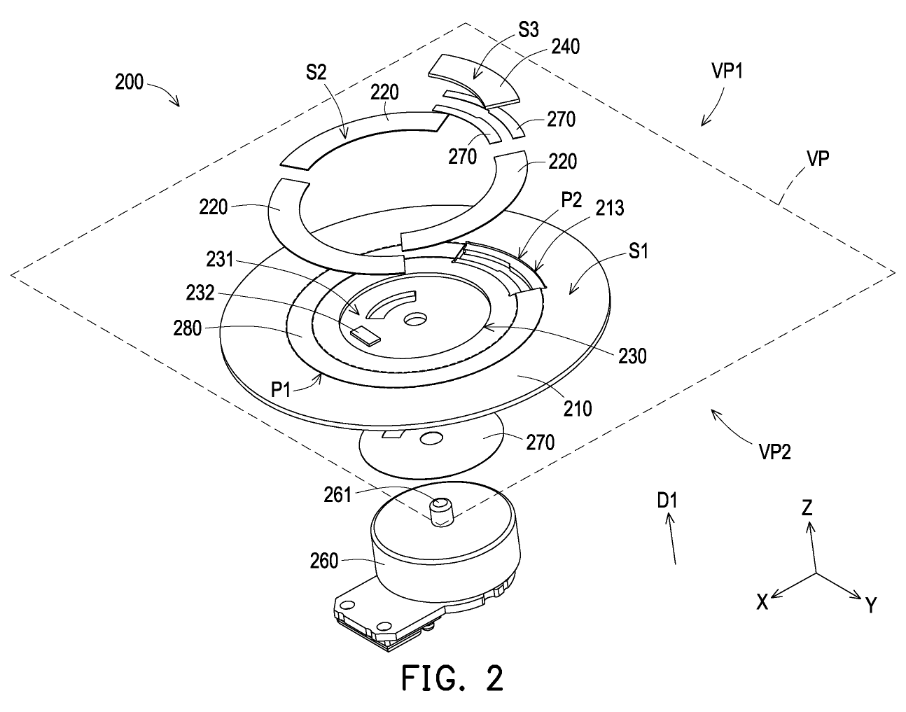

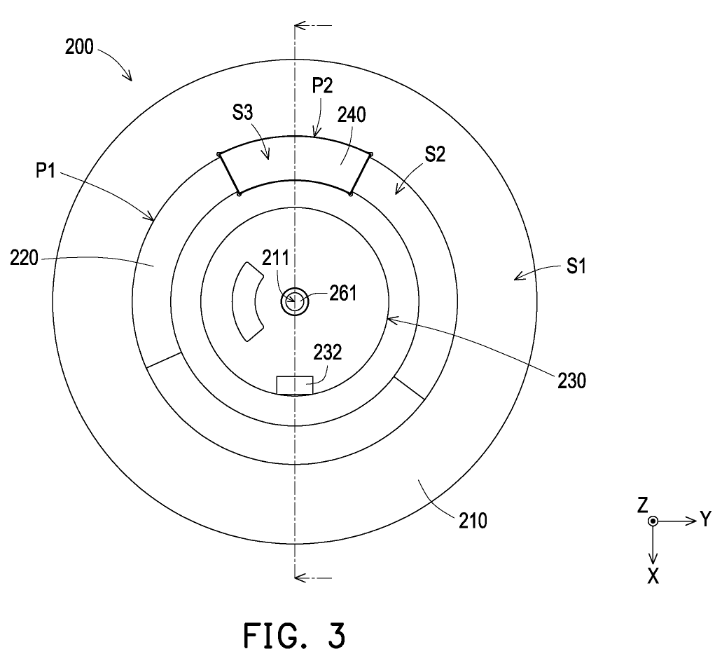

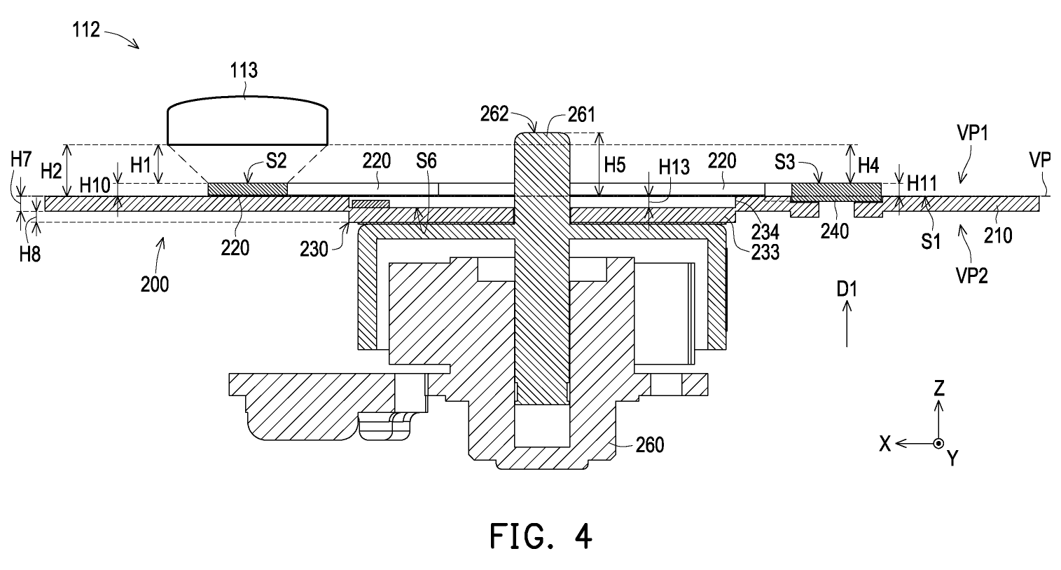

FIG. 1 is a block diagram of a projection device according to an embodiment of the invention. FIG. 2 is an exploded view of a wavelength conversion component of FIG. 1. FIG. 3 is a top view of the wavelength conversion component of FIG. 1. FIG. 4 is a cross-sectional schematic view of an optical device corresponding to FIG. 2. Some structures are omitted herein and a rectangular coordinate system X-Y-Z is provided to facilitate description of components. Referring to FIG. 1 to FIG. 4 together, a projection device 100 (e.g., a projector) includes an illumination system 110, a light valve module 120, and a lens module 130. The illumination system 110 is configured to provide an illumination light beam 300 and includes a light source module 111 and an optical device 112. The light source module 111 is configured to provide a laser light beam 310. The optical device 112 includes a light-collecting component 113 and a wavelength conversion component 200. The light-collecting component 113 is disposed on a transmission path of the laser light beam 310 from the light source module 111. The wavelength conversion component 200 is disposed on a transmission path of the laser light beam 310 from the light-collecting component 113 and is configured to convert the laser light beam 310 into a converted light beam 320. The illumination light beam 300 includes at least one of the laser light beam 310 and the converted light beam 320. The light valve module 120 is disposed on a transmission path of the illumination light beam 300 and is configured to convert the illumination light beam 300 into an image light beam 400. The lens module 130 is disposed on a transmission path of the image light beam 400 and is configured to project the image light beam 400 out of the projection device 100.

The light source module 111 may include, for example, a light-emitting diode (LED) component, a laser diode (LD) component, or a combination thereof, and may be a single light-emitting component or an array of light-emitting components. The light valve module 120 includes, for example, one of reflective light modulators such as a liquid crystal on silicon panel (LCoS panel), a digital micro-mirror device (DMD), etc. In some embodiments, the light valve module 120 may also include one of transmissive light modulators such as a transparent liquid crystal panel, an electro-optical modulator, a magneto-optic modulator, an acousto-optic modulator (AOM), etc. In the embodiments of the invention, the type and kind of the light valve module 120 are not limited. Regarding the method by which the light valve module 120 converts the illumination light beam 300 into the image light beam 400, its detailed steps and implementation methods can be obtained from the sufficient teaching, suggestions, and implementation instructions provided by the general knowledge in the art, so description thereof is not provided in detail. In this embodiment, the number of light valve module 120 is one, for example, a projection device using a single digital micro-mirror component, but in other embodiments not shown, there may be multiple ones.

The lens module 130 includes, for example, one or a plurality of lens combinations with refracting powers including various non-planar lens combinations of a biconcave lens, a biconvex lens, a concave-convex lens, a convex-concave lens, a plane-convex lens, and a plane-concave lens, for example. In an embodiment, the lens module 130 may also include planar, concave, or convex optical lenses for projecting the image light beam 400 onto a projection target (e.g., on a wall or a projection screen). In the embodiments of the invention, the type and kind of the (projection) lens module 130 are not limited.

The wavelength conversion component 200 of this embodiment is, for example, a transmissive phosphor wheel, a reflective phosphor wheel, or a scattering phosphor wheel. The light-collecting component 113 is a lens element, for example, a focusing lens element. FIG. 4 schematically illustrates the light-collecting component 113, and in the embodiments of the invention, the type of the light-collecting component 113 is not limited. The light-collecting component 113 of the optical device 112 is disposed on a first side VP1 of a virtual plane VP. The wavelength conversion component 200 includes a substrate 210, a wavelength conversion layer 220, and a counterweight structure 230. The substrate 210 includes a geometric center 211 (shown in FIG. 3) and a wavelength conversion region P1 located on a top surface S1 of the substrate 210. The wavelength conversion region P1 is, for example, arc-shaped, ring-shaped, or annular sector-shaped, and the wavelength conversion region P1 surrounds the geometric center 211. The top surface S1 of the substrate 210 is located on the virtual plane VP. The substrate 210 is, for example, an aluminum substrate or an aluminum alloy substrate. The wavelength conversion layer 220 is disposed on the wavelength conversion region P1. The wavelength conversion layer 220 has a top surface S2 on a side away from the substrate 210. A distance H10 is provided between the top surface S2 of the wavelength conversion layer 220 and the top surface S1 of the substrate 210. A first distance H1 is provided between the light-collecting component 113 and the top surface S2 of the wavelength conversion layer 220. A second distance H2 is provided between the light-collecting component 113 and the top surface S1 of the substrate 210. The first distance H1 is less than the second distance H2. A difference between the second distance H2 and the first distance H1 is the distance H10, and the distance H10 is approximately a thickness by which the wavelength conversion layer 220 protrudes from the top surface S1 of the substrate 210. The top surface S2 of the wavelength conversion layer 220 is located on the first side VP1 of the virtual plane VP. The counterweight structure 230 is connected to the substrate 210 and located on a second side VP2 of the virtual plane VP. The first side VP1 (facing the laser light beam 310) of the virtual plane VP is opposite to the second side VP2. That is, in this embodiment, the wavelength conversion layer 220 and the counterweight structure 230 are located on opposite sides of the top surface S1 of the substrate 210. The virtual plane VP is parallel to the X-Y plane, and the first side VP1 is located above the second side VP2 on the Z-axis. The substrate 210 of this embodiment is, for example, a hollow disk.

In order for the wavelength conversion layer 220 to have improved conversion efficiency, the light-collecting component 113 and the top surface S2 of the wavelength conversion layer 220 need to be spaced apart by a specific distance, so that a focal point formed after the laser light beam 310 from the light source module 111 passes through the light-collecting component 113 is located on the top surface S2 of the wavelength conversion layer 220. As shown in FIG. 1 and FIG. 4, during an assembly process of the projection device 100/illumination system 110/optical device 112, the specific distance between the light-collecting component 113 and the top surface S2 of the wavelength conversion layer 220 may change due to component tolerances between various components (e.g., optical elements like lens elements or reflective mirrors in the illumination system 110) in an optical path. The component tolerances of each projection device 100/illumination system 110/optical device 112 may be different. Therefore, during the assembly process of the optical device 112, the light-collecting component 113 may be moved relative to the wavelength conversion component 200 in an axial direction D1 (i.e., Z-axis) of the substrate 210 through a gap adjustment mechanism (not shown) to adjust the first distance H1. The first distance H1 of this embodiment is the distance of the focal point formed after the laser light beam 310 passes through the light-collecting component 113 (e.g., the first distance H1 is set to match the location of the focal point of the light-collecting component 113), for example, 0.7 millimeters.

In a wavelength conversion component of the related art, the top surface of the substrate and/or the counterweight structure may be closer to the light-collecting component than the top surface of the wavelength conversion layer. Therefore, during the assembly process of the projection device/illumination system, when an operator adjusts the position of the light-collecting component, the operator needs to consider the positions of the top surface of the substrate and/or the counterweight structure, which prevents the light-collecting component from being adjusted to the optimal position, so that conversion efficiency of the wavelength conversion layer is poor. In this embodiment, the first distance H1 is less than the second distance H2 and the counterweight structure 230 is located on the second side VP2 of the virtual plane VP. It thus can be known that compared to other assemblies and structures of the wavelength conversion component 200 (e.g., the substrate 210, counterweight structure 230, etc.), the top surface S2 of the wavelength conversion layer 220 is closest to the light-collecting component 113. Therefore, during the assembly process of the projection device 100/illumination system 110/optical device 112, when the operator adjusts the distance between the light-collecting component 113 and the top surface S2, the operator does not need to consider the positions of other assemblies (e.g., the counterweight structure 230), and the operator may adjust the light-collecting component 113 to the optimal position, allowing the light-collecting component 113 and the wavelength conversion layer 220 to maintain the optimal distance, so that the wavelength conversion layer 220 has improved conversion efficiency. Compared to a conventional wavelength conversion component of the related art, the conversion efficiency of the wavelength conversion component 200 of this embodiment may be improved by at least 5%. Further, after the component of the projection device 100/illumination system 110/optical device 112 is completed, when the wavelength conversion component 200 rotates relative to the light-collecting component 113, collision between the light-collecting component 113 and the top surface S1 of the substrate 210 and the counterweight structure 230 may be avoided, and damage to the light-collecting component 113 and/or the wavelength conversion component 200 is thus avoided.

As shown in FIG. 2 to FIG. 4, the substrate 210 further includes a non-wavelength conversion region P2. The wavelength conversion component 200 may include a non-wavelength conversion element 240 for reflecting the laser light beam 310 or allowing the laser light beam 310 to penetrate through the non-wavelength conversion element 240. The non-wavelength conversion element 240 is disposed on the non-wavelength conversion region P2 (blue light region). The non-wavelength conversion element 240 and the wavelength conversion layer 220 surround the geometric center 211. A top surface S3 of the non-wavelength conversion element 240 is located on the first side VP1 of the virtual plane VP, and a distance H11 is provided between the top surface S3 of the non-wavelength conversion element 240 and the top surface S1 of the substrate 210. The first distance H1 is less than or equal to a distance H4 between the light-collecting component 113 and the top surface S3 of the non-wavelength conversion element 240. The distance H11 is a thickness by which the non-wavelength conversion element 240 protrudes from the top surface S1 of the substrate 210 and is a difference between the second distance H2 and the distance H4. In this embodiment, the distance H4 is equal to the first distance H1, and the distance H11 is equal to the distance H10. That is, the top surface S2 of the wavelength conversion layer 220 and the top surface S3 of the non-wavelength conversion element 240 are coplanar. In other embodiments that are not shown, the distance H4 may be greater than the first distance H1, and the distance H11 may be less than the distance H10. For example, the non-wavelength conversion element 240 and the top surface S1 of the substrate 210 are coplanar (located on the virtual plane VP).

In this embodiment, since the first distance H1 is equal to the distance H4, when the wavelength conversion component 200 rotates such that the non-wavelength conversion element 240 is positioned below the light-collecting component 113 along the Z-axis (the non-wavelength conversion element 240 is disposed on the transmission path of the laser light beam 310 from the light-collecting component 113), the non-wavelength conversion element 240 is prevented from colliding with the light-collecting component 113. The focal point formed by the laser light beam 310 (FIG. 1) from the light source module 111 after passing through the light-collecting component 113 may be located on the top surface S3 of the non-wavelength conversion element 240, so that the non-wavelength conversion element 240 has improved optical efficiency. In other words, the light-collecting component 113 in this embodiment maintains optimal distances from both the wavelength conversion layer 220 and the non-wavelength conversion element 240, so that both the wavelength conversion layer 220 and the non-wavelength conversion element 240 have improved better efficiency. Compared to the wavelength conversion component where the top surface of the non-wavelength conversion element and the top surface of the wavelength conversion layer are not coplanar, the wavelength conversion component 200 of this embodiment has improved operational efficiency.

The non-wavelength conversion element 240 of this embodiment is, for example, a reflective mirror having a coating (e.g., a blue light reflective coating or an anti-reflective coating) for reflecting the laser light beam 310. In an embodiment, the substrate 210 may have a groove 213 disposed in the non-wavelength conversion region P2, and a bottom portion of the groove 213 has an opening. The non-wavelength conversion element 240 is disposed within the groove 213. In this way, the thickness of the non-wavelength conversion element 240 in the axial direction D1 of the substrate 210 may be greater than the thickness of the wavelength conversion layer 220 in the axial direction D1 and may be greater than the distance H11. In other embodiments that are not shown, the non-wavelength conversion element 240 may be a transmissive lens element to allow the laser light beam 310 to penetrate through the opening of the substrate 210. The wavelength conversion layer 220 is configured to convert the laser light beam 310 into a converted light beam 320. The wavelength conversion layer 220 of this embodiment is a phosphor sheet. The phosphor sheet includes but not limited to a green phosphor sheet, a yellow phosphor sheet, other color phosphor sheets, and a combination thereof, so as to convert the laser light beam 310 into fluorescent light beams (converted light beams) of different colors. In other embodiments that are not shown, the wavelength conversion layer 220 may be formed by curing a wavelength conversion adhesive coated on the substrate 210. In other embodiments, the wavelength conversion component 200 may not include the non-wavelength conversion element 240.

The light-collecting component 113 is used to focus the laser light beam 310 from the light source module 111 on a specific region (e.g., the top surface S2 of the wavelength conversion layer 220 and the top surface S3 of the non-wavelength conversion element 240) of the wavelength conversion component 200. As shown in FIG. 1 and FIG. 4, taking the wavelength conversion component 200 as a reflective fluorescent color wheel as an example, when the non-wavelength conversion element 240 is located on the transmission path of the laser light beam 310 from the light-collecting component 113, the non-wavelength conversion element 240 reflects the laser light beam 310 and transmits the laser light beam 310 out of the optical device 112 via the light-collecting component 113. Herein, the illumination light beam 300 provided by the illumination system 110 to the light valve module 120 is the laser light beam 310. When the wavelength conversion layer 220 is located on the transmission path of the laser light beam 310 from the light-collecting component 113, the wavelength conversion layer 220 converts the laser light beam 310 into the corresponding converted light beam 320 and transmits the converted light beam 320 out of the optical device 112 via the light-collecting component 113. Herein, the illumination light beam 300 provided by the illumination system 110 to the light valve module 120 is the converted light beam 320. It thus may be known that when the wavelength conversion component 200 rotates, in different time periods, one of the non-wavelength conversion element 240 and the wavelength conversion layer 220 is located on the transmission path of the laser light beam 310, such that the illumination light beam 300 is the laser light beam 310 or the converted light beam 320 in different time periods.

As shown in FIG. 3 and FIG. 4, the counterweight structure 230 includes a recessed structure 231 and a counterweight block 232 (e.g., a copper sheet). On the virtual plane VP, an orthogonal projection of the recessed structure 231 on the virtual plane VP and the substrate 210 are concentric circles. The counterweight block 232 is disposed within the recessed structure 231. A recessed direction of the recessed structure 231 is parallel to a direction of the laser light beam 310 (FIG. 1) from the light source module 111 incident on the wavelength conversion component 200 (i.e., parallel to the Z-axis and the axial direction D1). The recessed structure 231 includes a sidewall 234 and a base plate 233. The sidewall 234 surrounds the base plate 233 and is vertically connected to the base plate 233 and the substrate 210. The base plate 233 is parallel to the substrate 210 and has a surface S6 facing the light-collecting component 113. A distance between the surface S6 and the light-collecting component 113 in the axial direction D1 of the substrate 210 is greater than the second distance H2. A distance H13 is provided between the surface S6 of the recessed structure 231 and the top surface S1 of the substrate 210. The distance H13 may be greater than, equal to, or less than the distance H10 and may be less than or equal to a thickness H7 of the substrate 210 in the axial direction D1. The counterweight block 232 is disposed on the surface S6 of the base plate 233. The substrate 210 and the recessed structure 231 may be integrally formed. The recessed structure 231 of this embodiment is, for example, an inner concave circle formed by a stamping original substrate process to form the hollow disk-shaped substrate 210 and the recessed structure 231. In this embodiment, a counterweight ring protruding from the top surface S1 of the substrate 210 is not required to be disposed on the substrate 210, so costs are lowered. A thickness H8 of the recessed structure 231 protruding from the substrate 210 in a direction away from the light-collecting component 113 is less than or equal to the thickness H7 of the substrate 210 in the axial direction D1. The thickness H8 is a depth of the recessed structure 231 (i.e., the recessed depth of the recessed structure 231 relative to the top surface S1 of the substrate 210 and the virtual plane VP). The thickness H8 may be, for example, equal to the distance H10. The thickness H7 may be 0.7 millimeters. In other embodiments that are not shown, the thickness H8 is less than the thickness H7. In other embodiments that are not shown, the recessed structure 231 may be formed by a die casting process or a CNC machining process.

As shown in FIG. 2 and FIG. 4, the wavelength conversion component 200 further includes a motor 260. A rotating shaft 261 of the motor 260 protrudes from the substrate 210 at the geometric center 211 of the substrate 210, and a portion of the rotating shaft 261 is located on the first side VP1 of the virtual plane VP. A maximum width of an orthogonal projection of the light-collecting component 113 on the virtual plane VP is less than a radius of the substrate 210. Orthogonal projections of the rotating shaft 261 and the light-collecting component 113 on the virtual plane VP do not overlap. That is, the orthogonal projections of the rotating shaft 261 and the light-collecting component 113 on the virtual plane VP are misaligned. Therefore, when the wavelength conversion component 200 is rotating or when the optical device 112 is being assembled, the light-collecting component 113 is prevented from colliding with the rotating shaft 261. The rotating shaft 261 has a top surface 262 located on the first side VP1 of the virtual plane VP. In this embodiment, a distance H5 between the top surface 262 of the rotating shaft 261 and the top surface S1 of the substrate 210 is greater than or equal to the second distance H2. Preferably, the distance H5 is greater than the second distance H2 and less than a sum of the first distance H1 and the second distance H2, so as to prevent the rotating shaft 261 from occupying excessive volume in the optical device 112. In other embodiments that are not shown, the distance H5 may be less than the second distance H2. In this embodiment, the motor 260 contacts the counterweight structure 230, and a contact area between the motor 260 and the counterweight structure 230 is less than or equal to an area of the surface S6 of the base plate 233 of the recessed structure 231 of the counterweight structure 230.

The wavelength conversion component 200 may further include three adhesive layers 270 and an additional layer 280. The non-wavelength conversion element 240 is connected to the substrate 210 by two adhesive layers 270, and the motor 260 is connected to the base plate 233 of the recessed structure 231 of the counterweight structure 230 by one adhesive layer 270. The additional layer 280 is, for example, an adhesive layer or a reflective layer. The additional layer 280 of this embodiment is an adhesive layer and is disposed within the wavelength conversion region P1 for fixing the wavelength conversion layer 220 to the substrate 210. The adhesive layer is, for example, a photo-curable adhesive, a UV adhesive, or a high heat-resistant adhesive. In this embodiment, the difference between the second distance H2 and the first distance H1 (i.e., distance H10) is the sum of the thickness of the wavelength conversion layer 220 and the thickness of the additional layer 280. In other embodiments that are not shown, the additional layer 280 may be a reflective layer and disposed on the entire top surface S1 of the substrate 210. The reflective layer may be used to reflect the laser light beam 310 to replace the non-wavelength conversion element 240. The reflective layer located in the non-wavelength conversion region P2 is, for example, a scattering layer or a diffusion layer, which may be formed by mixing a colloid with titanium dioxide (TiO2), aluminum oxide (Al2O3), or other metal oxides. The reflective layer located below the wavelength conversion layer 220 is, for example, a metal plating layer (e.g., aluminum, silver, or a dielectric film with a thickness less than 5 micrometers), the aforementioned scattering layer or diffusion layer.

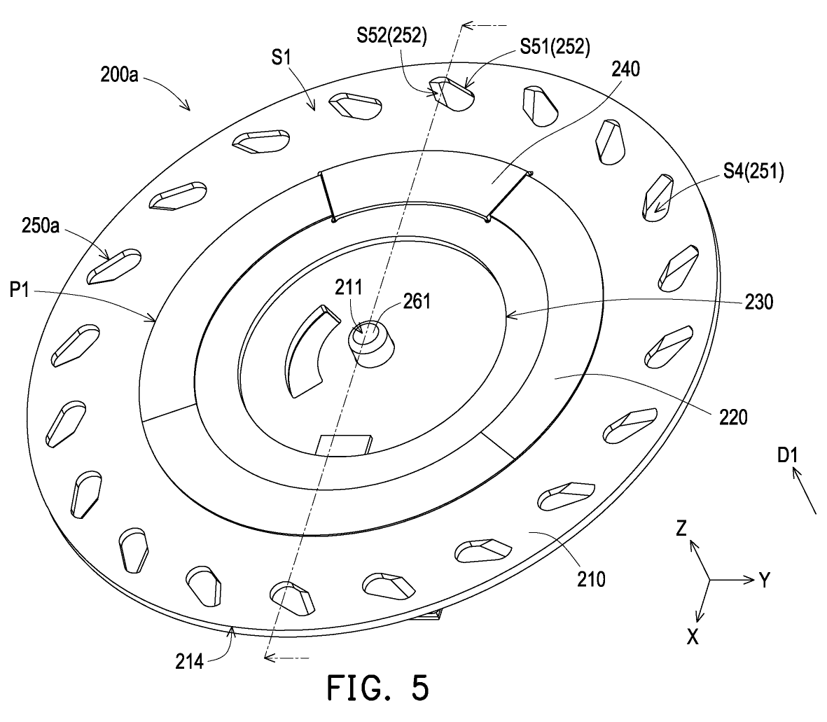

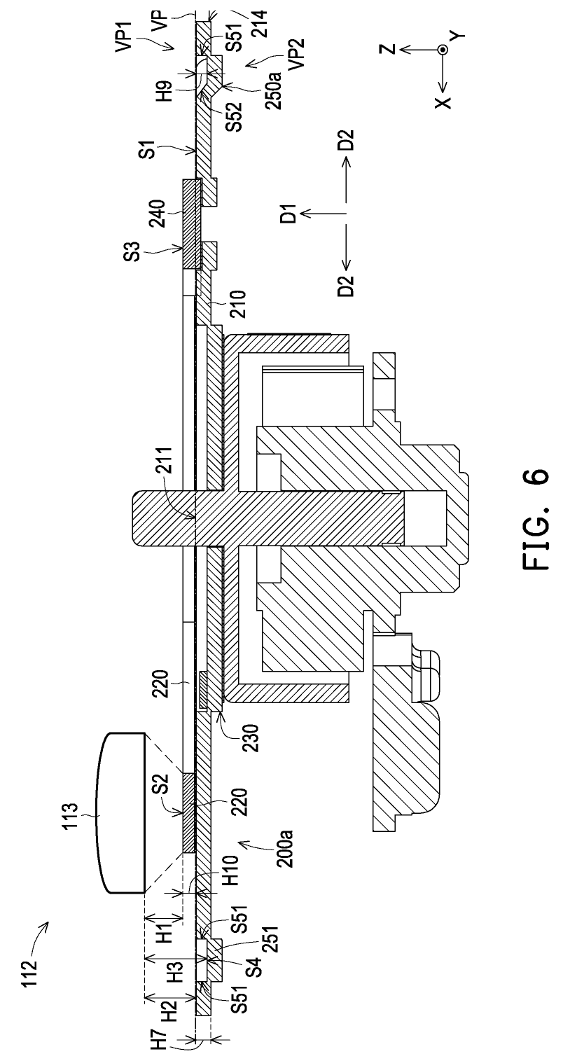

FIG. 5 is a schematic view of a wavelength conversion component according to an embodiment of the invention. FIG. 6 is a cross-sectional schematic view of the optical device corresponding to FIG. 5, in which two radial directions D2 parallel to the X-axis are schematically illustrated and part of the structure is omitted. Referring to FIG. 4 to FIG. 6 together, a wavelength conversion component 200a of this embodiment is similar to the wavelength conversion component 200 of FIG. 4 of the aforementioned embodiment, and the difference therebetween is that the wavelength conversion component 200a of this embodiment further includes a heat dissipation structure 250a. The heat dissipation structure 250a is connected to the substrate 210, and a third distance H3 is provided between the heat dissipation structure 250a and the light-collecting component 113, where the third distance H3 is greater than or equal to the first distance H1. A plurality of heat dissipation structures 250a may be located in the radial direction D2 of the substrate 210 between the wavelength conversion region P1 and the geometric center 211, between the wavelength conversion region P1 and the edge 214 of the substrate 210, or at both of the aforementioned positions. When the third distance H3 is greater than the second distance H2, the heat dissipation structure 250a is located on the second side VP2. When the third distance H3 is less than the second distance H2, the heat dissipation structure 250a is located on the first side VP1.

The heat dissipation structure 250a of this embodiment is located in the radial direction D2 of the substrate 210 between the wavelength conversion region P1 and the edge 214 of the substrate 210. The heat dissipation structure 250a is located on the second side VP2 of the virtual plane VP, that is, the wavelength conversion layer 220 and the heat dissipation structure 250a are located on opposite sides of the top surface S1 of the substrate 210. The heat dissipation structure 250a is a groove recessed from the top surface S1 of the substrate 210 toward the second side VP2, such that the third distance H3 is greater than the second distance H2 and the first distance H1. In other words, in this way, during the assembly process of the projection device 100/illumination system 110/optical device 112 (FIG. 1), when an operator adjusts the distance between the light-collecting component 113 and the top surface S2 of the wavelength conversion layer 220, it is not necessary to consider the height of other components (e.g., the counterweight structure 230 and the heat dissipation structure 250a). After the projection device 100/illumination system 110/optical device 112 is assembled, when the wavelength conversion component 200a rotates relative to the light-collecting component 113, the light-collecting component 113 is prevented from colliding with the heat dissipation structure 250a. The number of heat dissipation structures 250a in this embodiment is, for example, multiple, but it is not limited thereto. In other embodiments that are not shown, the number of heat dissipation structures 250a may be one.

The heat dissipation structure 250a of this embodiment is located in the radial direction D2 of the substrate 210 between the wavelength conversion region P1 and the edge 214 of the substrate 210. The heat dissipation structure 250a has a base plate 251 and a sidewall 252 connected to each other, and the sidewall 252 surrounds the base plate 251. The sidewall 252 is connected to the substrate 210, and the base plate 251 is parallel to the top surface S1 of the substrate 210. In this embodiment, the substrate 210 and the heat dissipation structure 250a may be integrally formed, and the heat dissipation structure 250a may be formed by a stamping original substrate process. In this way, the thickness H7 of the substrate 210 is greater than or equal to a distance H9 between the base plate 251 of the heat dissipation structure 250a and the top surface S1 of the substrate 210, and the distance H9 may be the difference between the third distance H3 and the second distance H2. When the heat dissipation structure 250a is located on the second side VP2, the distance H9 may be greater than, equal to, or less than the distance H10 between the top surface S2 of the wavelength conversion layer 220 and the top surface S1 of the substrate 210. In this embodiment, the heat dissipation structure 250a, the recessed structure 231, and the substrate 210 are integrally formed. The heat dissipation structure 250a and the recessed structure 231 are both recessed from the top surface S1 of the substrate 210, and the wavelength conversion component 200a has only the wavelength conversion layer 220, the rotating shaft 261, and/or the non-wavelength conversion element 240 protruding from the top surface S1 of the substrate 210. In other words, no components of the wavelength conversion component 200a protrude from the top surface S1 of the substrate 210 except for the wavelength conversion layer 220, the rotating shaft 261, and/or the non-wavelength conversion element 240.

The base plate 251 of the heat dissipation structure 250a has a surface S4 facing the light-collecting component 113, and the third distance H3 is provided between the surface S4 and the light-collecting component 113. The sidewall 252 of the heat dissipation structure 250a includes a first surface S51 and a second surface S52. The first surface S51 is perpendicular to the top surface S1 of the substrate 210 and is a vertical surface. The second surface S52 is not perpendicular to the top surface S1 of the substrate 210, is inclined relative to the top surface S1 of the substrate 210, and is an inclined surface. The sidewall 252 may further include a plane surface and/or a curved surface for connecting the first surface S51 and the second surface S52. The first surface S51 of this embodiment is, for example, a windward surface, and the second surface S52 is, for example, a leeward surface. When the wavelength conversion component 200a rotates in a clockwise direction, for example, most of the generated airflow directly blows toward the first surface S51. The first surface S51 may disturb most of the airflow to form turbulent flow, so that the heat exchange efficiency between the airflow and the wavelength conversion component 200 is improved. In the case where a diameter of the substrate 210 is 54 millimeters, compared to the wavelength conversion component 200 of FIG. 4, a temperature of the wavelength conversion component 200a of this embodiment may be reduced by approximately 5%.

In the process of producing the heat dissipation structure 250a of the wavelength conversion component 200a of this embodiment, a protective film (not shown) may be first disposed on a base material used to form the substrate 210, and then a stamping process may be performed to form the heat dissipation structure 250a. After the stamping process is completed, the protective film is removed. In this embodiment, since the second surface S52 of the heat dissipation structure 250a is an inclined surface, when the stamping process is performed to form the second surface S52, the protective film covering the second surface S52 is less likely to break. In this way, an operator may easily remove the protective film covering the top surface S1 of the substrate 210, the second surface S52, and the base plate 251 from the second surface S52, so that the manufacturing steps may thus be simplified. The wavelength conversion component 200a of this embodiment is similar to that of the aforementioned embodiments, so description thereof is not provided in detail herein.

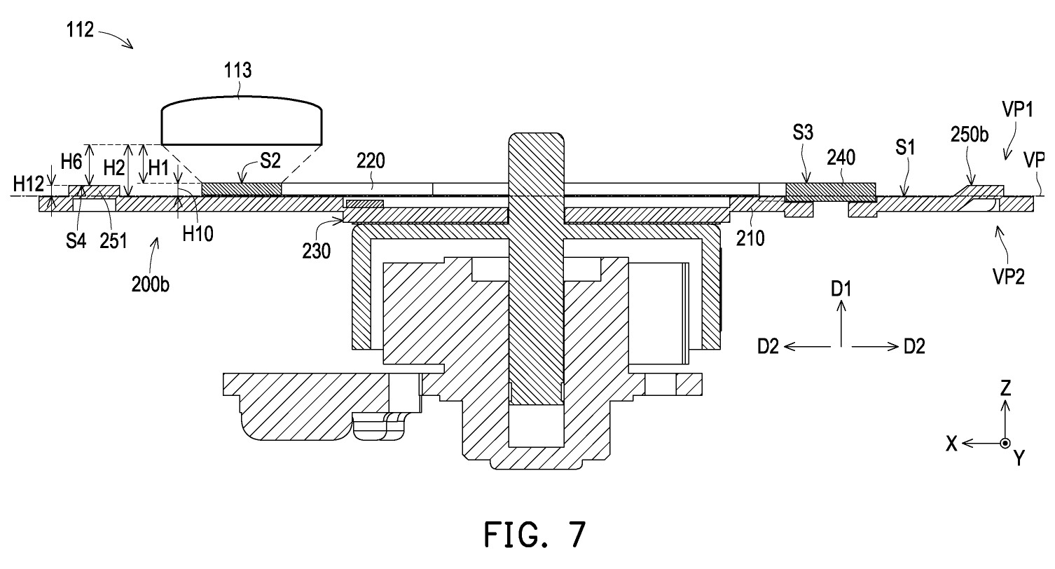

FIG. 7 is a cross-sectional schematic diagram of the optical device according to an embodiment of the invention, in which two radial directions D2 parallel to the X-axis are schematically illustrated and part of the structure is omitted. Referring to FIG. 6 to FIG. 7 together, a wavelength conversion component 200b of this embodiment is similar to the wavelength conversion component 200a of FIG. 6 of the aforementioned embodiment, and the difference therebetween is that the surface S4 of the base plate 251 of the heat dissipation structure 250b of this embodiment adjacent to the light-collecting component 113 is located on the first side VP1 of the virtual plane VP, and a distance H12 is provided between the surface S4 and the top surface S1 of the substrate 210. A third distance H6 between the surface S4 and the light-collecting component 113 is less than the second distance H2. The difference between the third distance H6 and the second distance H2 is the distance H12. The heat dissipation structure 250b is a protrusion protruding from the top surface S1 of the substrate 210 toward the first side VP1, so that the heat dissipation structure 250b is located on the first side VP1 of the virtual plane VP. When the heat dissipation structure 250b is located on the first side VP1 (i.e., the third distance H6 is less than the second distance H2), the distance H12 is less than or equal to the distance H10 between the top surface S2 of the wavelength conversion layer 220 and the top surface S1 of the substrate 210. The third distance H6 of this embodiment is greater than the first distance H1 and less than the second distance H2, and the distance H12 is less than the distance H10. In other embodiments that are not shown, the third distance H6 may be equal to the first distance H1, and the distance H12 may be equal to the distance H10. The wavelength conversion component 200b of this embodiment is similar to that (wavelength conversion component) of the aforementioned embodiments, so description thereof is not provided in detail herein.

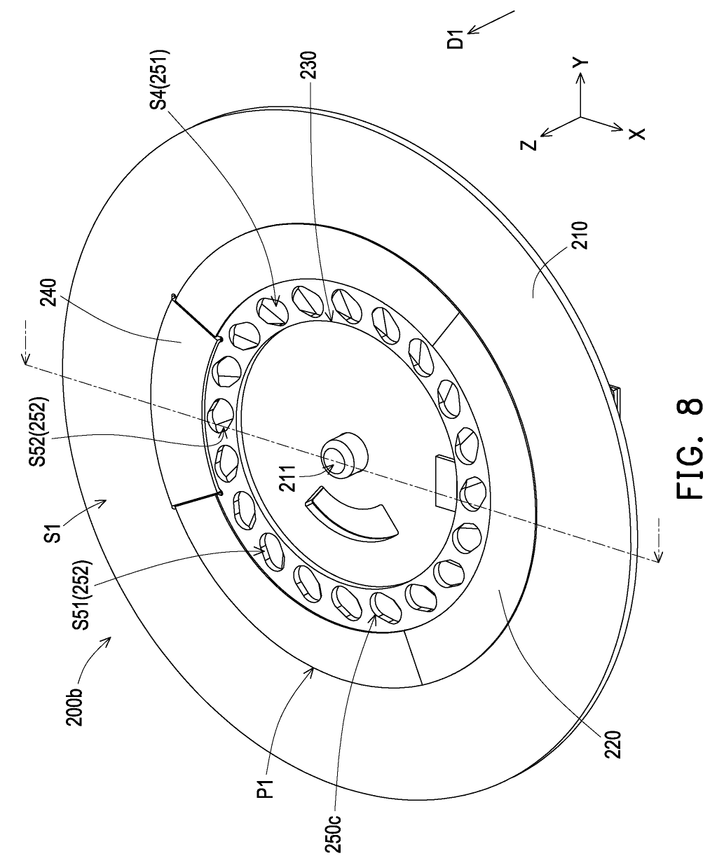

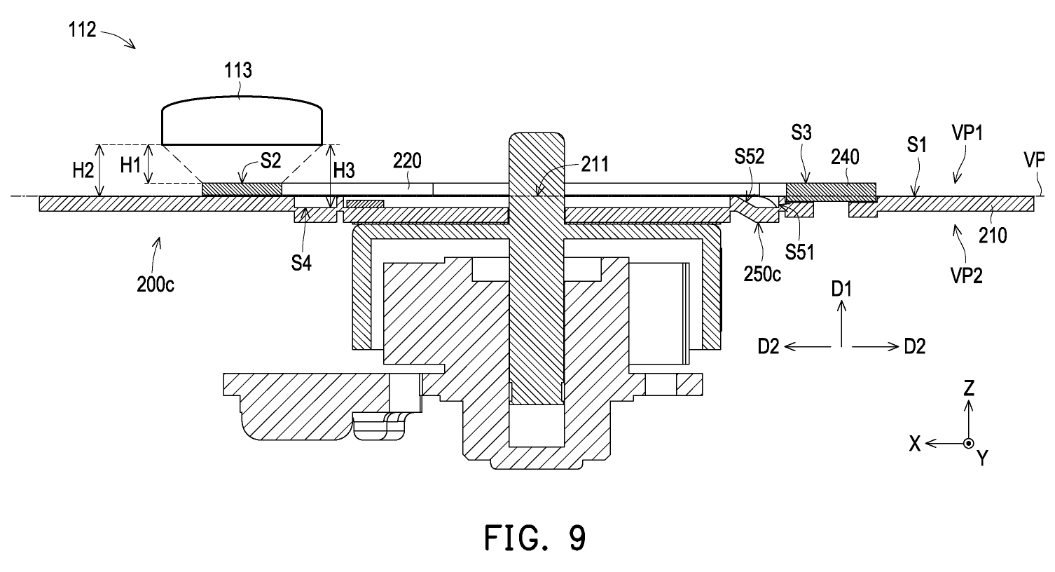

FIG. 8 is a schematic view of a wavelength conversion component according to an embodiment of the invention. FIG. 9 is a cross-sectional schematic view of the optical device corresponding to FIG. 8, in which two radial directions D2 parallel to the X-axis are schematically illustrated and part of the structure is omitted. Referring to FIG. 6, FIG. 8, and FIG. 9 together, a wavelength conversion component 200c of this embodiment is similar to the wavelength conversion component 200a of FIG. 6 of the aforementioned embodiment, and the difference therebetween is that a plurality of heat dissipation structures 250c of this embodiment are located between the wavelength conversion region P1 and the geometric center 211 in the radial direction D2 of the substrate 210. Compared to the heat dissipation structure 250b of FIG. 6, the heat dissipation structure 250c of this embodiment has a smaller size due to being limited by an installation area. In the case where the diameter of the substrate 210 is 54 millimeters, compared to the wavelength conversion component 200 of FIG. 4, a temperature of the wavelength conversion component 200c of this embodiment may be reduced by approximately 7%. The wavelength conversion component 200c of this embodiment is similar to that of the aforementioned embodiments, so description thereof is not provided in detail herein.

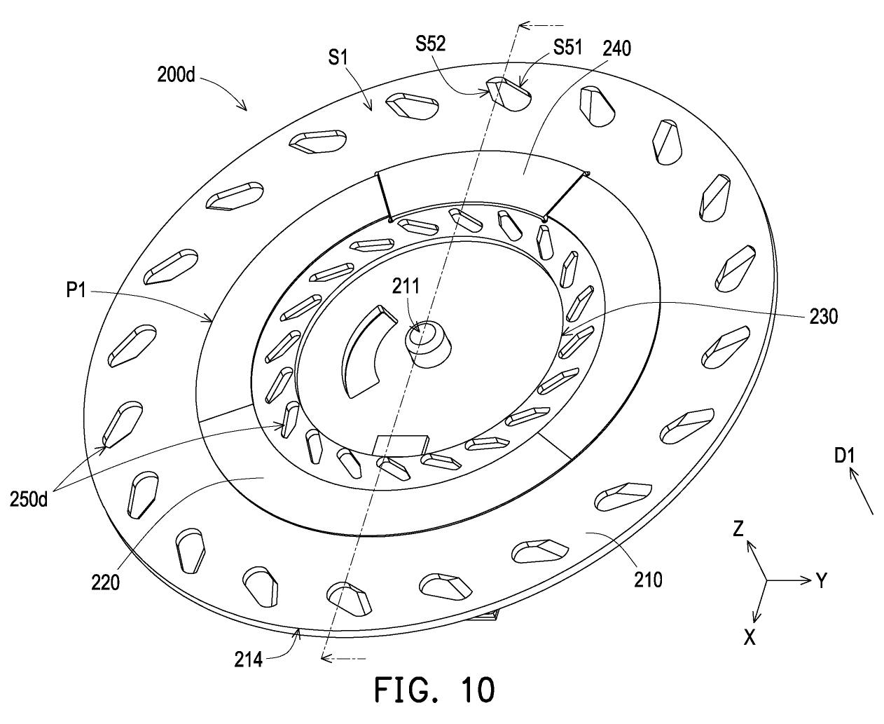

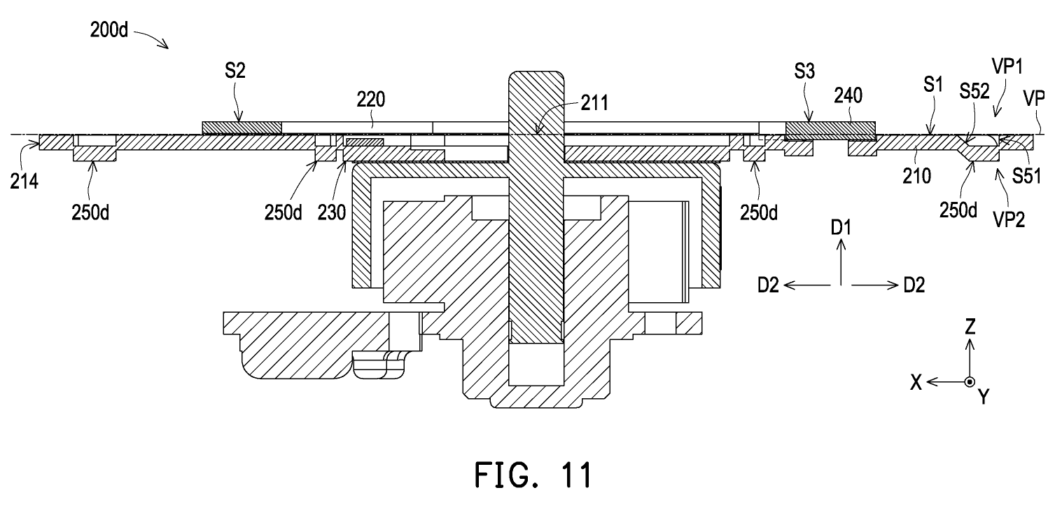

FIG. 10 is a schematic view of a wavelength conversion component according to an embodiment of the invention. FIG. 11 is a cross-sectional view of the wavelength conversion component of FIG. 10, in which two radial directions D2 parallel to the X-axis are schematically illustrated and part of the structure is omitted. Referring to FIG. 6, FIG. 10, and FIG. 11 together, a wavelength conversion component 200d of this embodiment is similar to the wavelength conversion component 200a of FIG. 6 of the aforementioned embodiment, and the difference therebetween is that part of a plurality of heat dissipation structures 250d of this embodiment are located between the wavelength conversion region P1 and the geometric center 211 in the radial direction D2 of the substrate 210, and another part are located between the wavelength conversion region P1 and the edge 214 of the substrate 210 in the radial direction D2 of the substrate 210. The wavelength conversion component 200d of this embodiment has the plurality of heat dissipation structures 250d disposed on both an inner side and an outer side relative to the wavelength conversion region P1, and therefore has good heat dissipation effect. In the case where the diameter of the substrate 210 is 54 millimeters, compared to the wavelength conversion component 200 of FIG. 4, a temperature of the wavelength conversion component 200d of this embodiment may be reduced by approximately 11%. The wavelength conversion component 200d of this embodiment is similar to that of the aforementioned embodiments, so description thereof is not provided in detail herein.

In view of the foregoing, the optical device and the projection device of the embodiments of the invention have at least one of the following advantages. The light-collecting component and the top surface of the wavelength conversion layer of the wavelength conversion component are located on the first side of the virtual plane, the counterweight structure is located on the second side of the virtual plane, the top surface of the substrate is located on the virtual plane, and a specific distance may be provided between the light-collecting component and the wavelength conversion component. In this way, the wavelength conversion component has improved conversion efficiency. Further, when the wavelength conversion component rotates relative to the light-collecting component, or during the assembly process of the optical device, collision between the light-collecting component and the substrate and the counterweight structure that may cause damage may be avoided.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The use of “at least one of...and...” thereof herein may include “one or more of the items contained in the list”. For example, the use of “at least one of A and B” thereof herein may include only A, or only B, or A and B. Similarly, the use of “at least one of A, B, and C” thereof herein may include only A, or only B, or only C, or any combination of A, B, and C. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the invention is provided to comply with the rules requiring an abstract, which will allow a searcher to quickly ascertain the subject matter of the technical invention of any patent issued from this invention. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present invention is intended to be dedicated to the public regardless of whether the element or component is explicitly recited in the following claims.

What is claimed is:

1. An optical device, comprising:
a light-collecting component disposed on a first side of a virtual plane; and
a wavelength conversion component, comprising:
a substrate comprising a wavelength conversion region and a geometric center, wherein the wavelength conversion region surrounds the geometric center, and a top surface of the substrate is located on the virtual plane;
a wavelength conversion layer disposed on the wavelength conversion region, wherein a first distance is provided between the light-collecting component and a top surface of the wavelength conversion layer, a second distance is provided between the light-collecting component and the top surface of the substrate, the first distance is less than the second distance, and the top surface of the wavelength conversion layer is located on the first side of the virtual plane; and
a counterweight structure connected to the substrate and located on a second side of the virtual plane, wherein the first side is opposite to the second side.

2. The optical device according to claim 1, wherein the wavelength conversion component comprises a heat dissipation structure connected to the substrate, a third distance is provided between the heat dissipation structure and the light-collecting component, and the third distance is greater than or equal to the first distance.

3. The optical device according to claim 2, wherein the third distance is greater than the second distance, and the heat dissipation structure is located on the second side of the virtual plane.

4. The optical device according to claim 2, wherein a thickness of the substrate is greater than or equal to a distance between the heat dissipation structure and the top surface of the substrate.

5. The optical device according to claim 2, wherein the heat dissipation structure comprises a base plate and a sidewall surrounding the base plate and connected to the substrate, the third distance is provided between the base plate and the light-collecting component, the sidewall comprises a first surface and a second surface, the first surface is perpendicular to the top surface of the substrate, and the second surface is not perpendicular to the top surface of the substrate.

6. The optical device according to claim 2, wherein the third distance is less than the second distance, and the heat dissipation structure is located on the first side of the virtual plane.

7. The optical device according to claim 2, wherein a plurality of heat dissipation structures are provided, and in a radial direction of the substrate, the heat dissipation structures are disposed at any one of the following positions:
(i) between the wavelength conversion region and the geometric center;
(ii) between the wavelength conversion region and an edge of the substrate, or
(iii) a combination of both above.

8. The optical device according to claim 1, wherein the wavelength conversion component comprises a motor, a rotating shaft of the motor protrudes from the substrate at the geometric center, a portion of the rotating shaft is located on the first side of the virtual plane, and the rotating shaft and the light-collecting component have non-overlapping orthogonal projections on the virtual plane.

9. The optical device according to claim 8, wherein the rotating shaft has a top surface located on the first side of the virtual plane, and a distance between the top surface of the rotating shaft and the top surface of the substrate is greater than or equal to the second distance between the light-collecting component and the top surface of the substrate.

10. The optical device according to claim 1, wherein the wavelength conversion component comprises a non-wavelength conversion element, the substrate further comprises a non-wavelength conversion region, the non-wavelength conversion element is disposed in the non-wavelength conversion region, the non-wavelength conversion element and the wavelength conversion layer surround the geometric center, a top surface of the non-wavelength conversion element is located on the first side of the virtual plane, and the first distance between the light-collecting component and the top surface of the wavelength conversion layer is less than or equal to a distance between the light-collecting component and the top surface of the non-wavelength conversion element.

11. A projection device, comprising:
an illumination system configured to provide an illumination light beam, the illumination system comprising:
a light source module configured to provide a laser light beam; and
an optical device, comprising:
a light-collecting component disposed on a transmission path of the laser light beam from the light source module and disposed on a first side of a virtual plane; and
a wavelength conversion component disposed on a transmission path of the laser light beam from the light-collecting component and configured to convert the laser light beam into a converted light beam, wherein the illumination light beam comprises at least one of the laser light beam and the converted light beam, and the wavelength conversion component comprises:
a substrate comprising a wavelength conversion region and a geometric center, wherein the wavelength conversion region surrounds the geometric center, and a top surface of the substrate is located on the virtual plane;
a wavelength conversion layer disposed on the wavelength conversion region, wherein a first distance is provided between the light-collecting component and a top surface of the wavelength conversion layer, a second distance is provided between the light-collecting component and the top surface of the substrate, the first distance is less than the second distance, and the top surface of the wavelength conversion layer is located on the first side of the virtual plane; and
a counterweight structure connected to the substrate and located on a second side of the virtual plane, wherein the first side is opposite to the second side;
a light valve module disposed on a transmission path of the illumination light beam and configured to convert the illumination light beam into an image light beam; and
a lens module disposed on a transmission path of the image light beam and configured to project the image light beam out of the projection device.

12. The projection device according to claim 11, wherein the wavelength conversion component comprises a heat dissipation structure connected to the substrate, a third distance is provided between the heat dissipation structure and the light-collecting component, and the third distance is greater than or equal to the first distance.

13. The projection device according to claim 12, wherein the third distance is greater than the second distance, and the heat dissipation structure is located on the second side of the virtual plane.

14. The projection device according to claim 12, wherein a thickness of the substrate is greater than or equal to a distance between the heat dissipation structure and the top surface of the substrate.

15. The projection device according to claim 12, wherein the heat dissipation structure comprises a base plate and a sidewall surrounding the base plate and connected to the substrate, the third distance is provided between the base plate and the light-collecting component, the sidewall comprises a first surface and a second surface, the first surface is perpendicular to the top surface of the substrate, and the second surface is not perpendicular to the top surface of the substrate.

16. The projection device according to claim 12, wherein the third distance is less than the second distance, and the heat dissipation structure is located on the first side of the virtual plane.

17. The projection device according to claim 12, wherein a plurality of heat dissipation structures are provided, and in a radial direction of the substrate, the heat dissipation structures are disposed at any one of the following positions:
(i) between the wavelength conversion region and the geometric center;
(ii) between the wavelength conversion region and an edge of the substrate, or
(iii) a combination of both above.

18. The projection device according to claim 11, wherein the wavelength conversion component comprises a motor, a rotating shaft of the motor protrudes from the substrate at the geometric center, a portion of the rotating shaft is located on the first side of the virtual plane, and the rotating shaft and the light-collecting component have non-overlapping orthogonal projections on the virtual plane.

19. The projection device according to claim 18, wherein the rotating shaft has a top surface located on the first side of the virtual plane, and a distance between the top surface of the rotating shaft and the top surface of the substrate is greater than or equal to the second distance between the light-collecting component and the top surface of the substrate.

20. The projection device according to claim 11, wherein the wavelength conversion component comprises a non-wavelength conversion element, the substrate further comprises a non-wavelength conversion region, the non-wavelength conversion element is disposed in the non-wavelength conversion region, the non-wavelength conversion element and the wavelength conversion layer surround the geometric center, a top surface of the non-wavelength conversion element is located on the first side of the virtual plane, and the first distance between the light-collecting component and the top surface of the wavelength conversion layer is less than or equal to a distance between the light-collecting component and the non-wavelength conversion element.
